(19) United States
(12) Patent Application Publication
(10) Pub. No.: US 2005/0129289 A1
(43) Pub. Date: Jun. 16, 2005

(54) Authentication with biometric data

(76) Inventors: Josef Birchbauer, A-Studenzen (AT); Wolfgang Marius, Graz/Kroisbach (AT); Arno Raunegger, Graz (AT)

Correspondence Address: BELL, BOYD & LLOYD, LLC, P. O. BOX 1135, CHICAGO, IL, 60690-1135, US

(21) Appl. No.: 10/514,573

(22) PCT Filed: May 6, 2003
(86) PCT No.: PCT/DE03/01445

(30) Foreign Application Priority Data
May 14, 2002 (DE) 102214220

(51) Int. Cl. G06K 9/00

(52) U.S. Cl. 382/124

(57) ABSTRACT

An authentication method is provided for biometric characteristic data, especially characteristic data taken from finger-prints. The characteristic data is captured at least twice for each authentication request, and a position alteration between successive captures is evaluated and rated.

### BACKGROUND OF THE INVENTION

The traces remaining on the surface of the sensor during normal use of capacitative fingerprint sensors can, in many instances, create an after-image of the fingerprint if manipulated in the right way. This can be of such high quality that it is accepted by the image processing unit and provides characteristics that can be evaluated. In some circumstances, these may correspond to the last finger applied and may result in false acceptance.

In the case of known methods or sensors, the list of characteristics of consecutively captured fingerprints must not exceed a defined degree of similarity. For example, it is required that images must differ from one another by a minimum amount in terms of translation and rotation. Together with suitable user prompting, this requires the user to always present the finger in a new position for each request procedure. A main memory and local peripherals of a data processing device are used as a memory for the list of characteristics most recently determined by the sensor.

The present invention seeks to improve latent image rejection in an authentication method as referred to above.

### SUMMARY OF THE INVENTION

Accordingly, the present invention provides an authentication method with biometric characteristic data, particularly biometric characteristic data obtained from finger prints, wherein the characteristic data is captured at least twice for every authentication request, and a change of position between consecutive captures is evaluated and rated.

In an embodiment of the method, evaluating the change of position takes the form of a direct comparison of the characteristic data.

In a further embodiment of the method, in order to evaluate the change of position, the position of a sensor fixed point is projected out of the characteristic data and the orientation thereof is recorded.

Additional features and advantages of the present invention are described in, and will be apparent from, the following Detailed Description of the Invention and the Figures.

### BRIEF DESCRIPTION OF THE FIGURES

FIG. 1 shows the sequence of the method according to the present invention.

FIG. 2 shows a variant for determining the position of a fingerprint in accordance with the present invention.

### DETAILED DESCRIPTION OF THE INVENTION

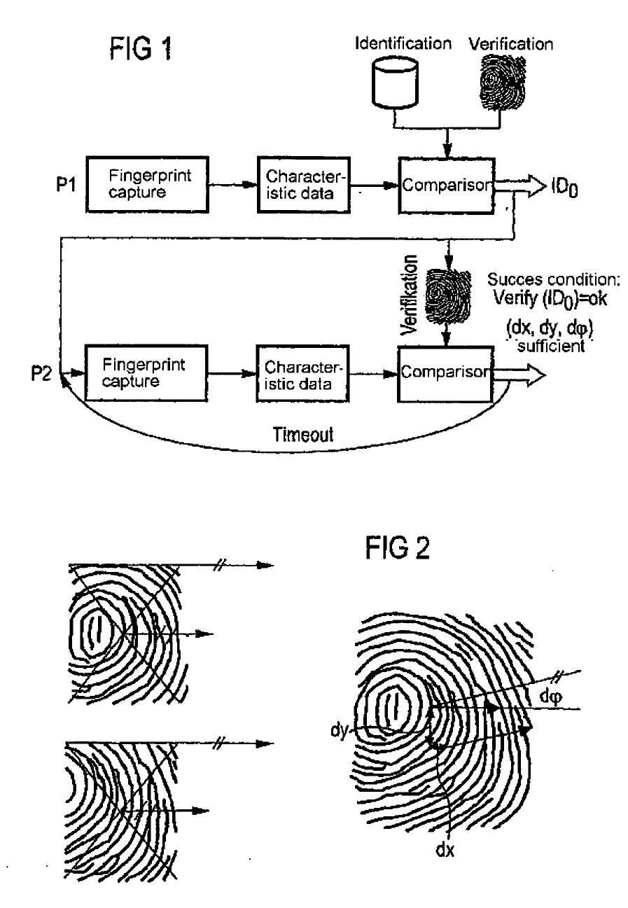

The authentication method according to the present invention is based on the principle illustrated in FIG. 1, whereby following successful recognition the same finger is repeatedly presented until sufficient differences exist in the relative orientation.

Accordingly, in the authentication method according to the present invention, there is no need to store the characteristics or characteristic data most recently determined.

In phase P1 characteristic data is extracted as normal from the fingerprint image captured and is compared, depending on the scenario, with an individual reference, in a verification, or an archive of references, in an identification. A capacitative fingerprint sensor is used, for example, to capture the fingerprint.

If the identification is positive, the system switches to phase P2, in which the steps referred to previously are run through cyclically until the relative offset (dx,dy) and/or the relative rotation d(p exceed predefined minimum values or a timeout occurs.

In this connection, it should be noted that phase P2 can always be performed as a verification in consequence of the knowledge of the identity in question. Phase P2 is thus independent of the size of the archive. This is particularly advantageous in the case of less powerful hardware, such as in the case of embedded systems, when a real-time-capable response behavior appears essential for usability.

There are, in principle, two options for rating the relative orientation:
A first variant provides for a direct reference to be created between the request prints captured and the characteristic data obtained therefrom.
A second variant, as shown in FIG. 2, entails projecting a fixed point on the sensor, such as, for example, the sensor mid-point indicated by a direction arrow, into the coordinates system of the reference and rating the relative orientation in the reference area.

The second variant can be categorized as more general, since it functions even when the offset is relatively large, whereas in the case of the first variant it is possible, in some circumstances, that a reference no longer can be created. However, in the absence of any reference, a sufficient offset can be assumed.

Depending on the preference of the user, there are various sequences of motions in order to selectively vary the position of the finger on the sensor. “Shifted Double Click” (SDC) is a slight adaptation of a sequence of motions which is familiar to all computer users who use a computer mouse. Alternatively, it is possible to rotate the finger slightly, or if the pressure is reduced to move the finger directly on the sensor.

The authentication method according to the present invention provides the following advantages compared to previous solutions:
Shifted Double Click (SDC) as against a comparison with a latency template of the most recently determined characteristics, stored in non-volatile manner.

Firstly, with SDC it is no longer necessary to store a latency template permanently. This is particularly advantageous in the case of client-server applications, where given that a number of terminals are operated simultaneously, the effort needed to administer the individual latency templates is no longer required. For security reasons as well, it would seem to be preferable to leave as few traces as possible behind in respect of the last identification procedure. Furthermore, with SDC the sequence of motions becomes a permanent part of the identification procedure and, thus, is more familiar to the user than sporadic requests to apply the finger once again in an offset position.
Shifted Double Click (SDC) as against applying a different finger following each successful identification.

An advantage here is that each user (among other things, for reasons of familiarity) preferably applies a particular finger. In addition, the next time a person logs on, he/she often cannot remember which finger he/she applied the last time. If account is also taken of the fact that a finger may be temporarily unusable, perhaps because of injury, the system needs to learn one finger more than in SDC, with the same failsafe security.

Finally, the method according to the present invention helps to reduce the risk of a false acceptance of an unauthorized user.

Since a false acceptance often occurs only in connection with a particular segment of an image, varying the position and, thus, the segment of the image observed reduces the probability of false alarms. There is no risk of an increase in the false rejection rate since the user has the opportunity of moving his/her finger slightly within a reasonable period of time.

Although the present invention has been described with reference to specific embodiments, those of skill in the art will recognize that changes may be made thereto without departing from the spirit and scope of the present invention as set forth in the hereafter appended claims.

1-3. (canceled)

4. An authentication method with biometric characteristic data obtained from fingerprints, comprising:
capturing the characteristic data at least twice for every authentication request; and
evaluating and rating a change of position between consecutive captures of the characteristic data.

5. An authentication method with biometric characteristic data obtained from fingerprints as claimed in claim 4, wherein the change of position includes directly comparing the characteristic data.

6. An authentication method with biometric characteristic data obtained from fingerprints as claimed in claim 4, wherein evaluating the change of position includes projecting a position of a sensor fixed point into the characteristic data and recording an associated orientation thereof.
